(19) United States
(12) Patent Application Publication
(10) Pub. No.: US 2026/0148595 A1
(43) Pub. Date: May 28, 2026

(54) METHOD FOR EPS RUNNING DATA ONLINE LOGGING AND STATISTICS

(71) Applicant: Steering Solutions IP Holding Corporation, Saginaw, MI (US)

(72) Inventors: Yu WANG, Suzhou (CN); Xiao TANG, Suzhou (CN); Di ZHAO, Suzhou (CN)

(21) Appl. No.: 18/967,039

(22) Filed: Dec. 3, 2024

(30) Foreign Application Priority Data
Nov. 28, 2024 (CN) 2024117215339

(51) Int. Cl. G07C 5/08; G07C 5/10

(52) U.S. Cl. CPC G07C 5/085; G07C 5/10

(57) ABSTRACT

A method for obtaining diagnostic data for an electronic power steering (EPS) system of a vehicle including, using one or more processors associated with the EPS system, receiving one or more inputs indicating respective operating characteristics associated with the EPS system, determining, from among a first plurality of measurement ranges, a first measurement range of a first operating characteristic corresponding to the one or more inputs, the one or more inputs indicating that the first operating characteristic is within the first measurement range, and incrementing a first counter corresponding to the first measurement range. The first counter stores a first value indicating a number of occurrences of the first operating characteristic within the first measurement range and the diagnostic data includes the first value stored by the first counter.

### CROSS-REFERENCE TO RELATED APPLICATIONS

This application claims the benefit of Chinese Application No. 2024117215339, filed on Nov. 28, 2024. The entire disclosure of the application referenced above is incorporated herein by reference.

### TECHNICAL FIELD

This disclosure relates to monitoring, collecting, and analyzing data communicated within embedded systems, such as electronic power steering (EPS) systems of vehicles.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

This disclosure relates generally to monitoring, collecting (e.g., logging), and analyzing data communicated within EPS systems of vehicles.

An aspect of the disclosed embodiments includes a method for obtaining diagnostic data for an electronic power steering (EPS) system of a vehicle. The method includes, using one or more processors associated with the EPS system, receiving one or more inputs indicating respective operating characteristics associated with the EPS system, determining, from a first plurality of measurement ranges, a first measurement range of a first operating characteristic corresponding to the one or more inputs, the one or more inputs indicating that the first operating characteristic is within the first measurement range, and incrementing a first counter corresponding to the first measurement range. The first counter stores a first value indicating a number of occurrences of the first operating characteristic within the first measurement range and the diagnostic data includes the first value stored by the first counter.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 1C generally illustrates components of an electronic power steering system (EPS) according to the principles of the present disclosure.

FIG. 2A generally illustrates an example diagnostic system according to the principles of the present disclosure.

FIG. 2B generally illustrates one-dimensional diagnostic data obtained using the systems and methods according to the principles of the present disclosure.

FIG. 2C generally illustrates two-dimensional diagnostic data obtained using the systems and methods according to the principles of the present disclosure.

FIG. 3 is a flow diagram generally illustrating a method for measuring, storing, and using diagnostic data according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Such a steering system and/or other components of the vehicle may generate various data, which may be processed by one or more controllers of the vehicle. The data may be associated with any aspect of the vehicle and/or vehicle operation including, but not limited to, data indicating anomalies and/or faults in operations of the vehicle.

In some examples, data identifying various operational issues (e.g., trouble or failure codes) can be obtained from the vehicle (e.g., via a port providing access to a vehicle communication network, such as a controller area network (CAN) of the vehicle). As one example, a diagnostic tool (e.g., a diagnostic tool or application implemented on an external computing device, such as a laptop or other device configured to connect to the port) may be configured to retrieve data from one or more vehicle systems in accordance with a unified diagnostic services (UDS) or other communication protocol.

In EPS and/or other types of systems, data such as failure codes and snapshot data can be extracted using UDS techniques (e.g., using external devices configured to communicate with vehicle system in accordance with UDS protocols) for issue analysis and troubleshooting. However, extracting data using UDS techniques is typically limited to collecting/logging failure moment data (i.e., data or information available at a precise moment/timestamp that a failure occurred). In other words, UDS techniques may not provide monitoring or logging of historical statistics data, such as running data, thermal load data, voltage and current distribution data, etc.

In other examples, data logging may be implemented using cloud computing or other distributed data storage/processing techniques. However, these techniques require processing and packaging of data collected in real-time and transmitting the data to remote a system/server (e.g., via a vehicle telematics box (T-box) and gateway), which requires high data traffic bandwidth and limits data and vehicle tracing capabilities.

Accordingly, collecting and analyzing historical data and locating, identifying, and defining faults in EPS systems of vehicles is not possible or is extremely difficult using existing systems and methods.

Diagnostic systems and methods according to the principles of the present disclosure are configured to monitor and collect/log data associated with operation of an EPS system (which may be referred to herein as historical data or diagnostic data). Monitoring the diagnostic data according to the present disclosure includes collecting and storing the diagnostic data locally (e.g., by and within the EPS system). As one example, an embedded controller or control circuitry, such as a microcontroller unit (MCU) associated with the EPS system, is configured to collect and store the diagnostic data for subsequent retrieval (e.g., retrieval by an external diagnostic tool or device, such as a computing device configured to connect to and communicate with vehicle systems using a port, which may be referred to as a diagnostic port).

As one example, the controller is configured to monitor and store operating data and store the diagnostic data indicating various characteristics of the operating data. As used herein, the term “operating data” may be distinct from the diagnostic data and corresponds to actual operating characteristics, measured or sensed values, etc. associated with operation of the EPS system. For example, the operating data may correspond to measured, sensed, calculated or estimated voltages, currents, temperatures, speeds, torques, etc., and may include values obtained directly from sensors, a vehicle or EPS system communication bus, and/or other sources. The diagnostic data may include one or more counts or counters indicating a number of occurrences of different operating characteristics within different interval ranges, which can be readily obtained and stored within an embedded controller of the EPS system, such as an EPS MCU. The number of occurences of various operating characteristics within the different interval ranges may provide more detailed information regarding faults, including both information prior to the occurence of any faults (e.g., for fault prevention/prediction) and information about behavior of the EPS system leading up to the actual occurence of a fault.

The systems and methods of the present disclosure may further be used to collect historical driving data, which can be used to analyze product life load spectrum data. With spectrum data, product iteration design can be achieved to strengthen high load components, use alternatives for over-designed components, etc.

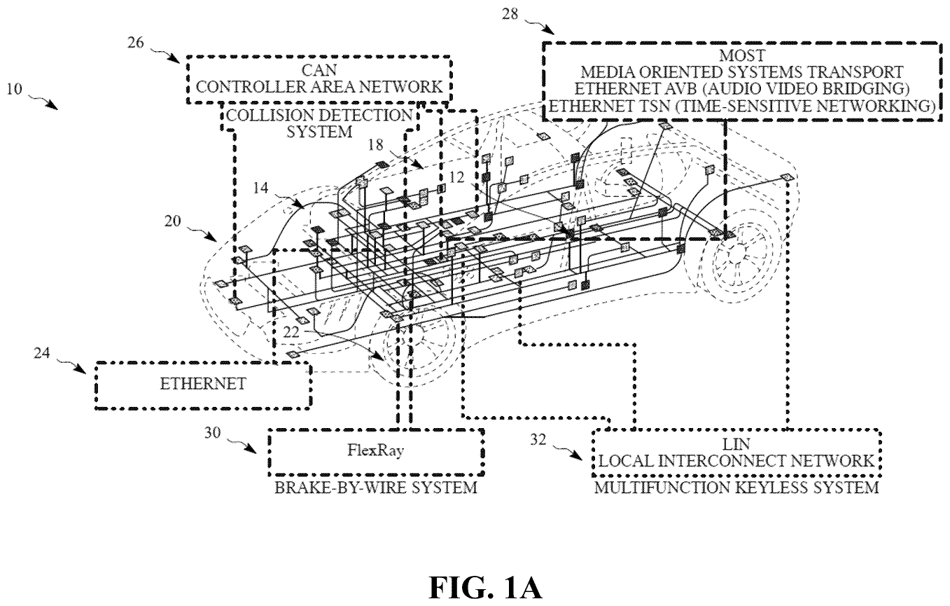

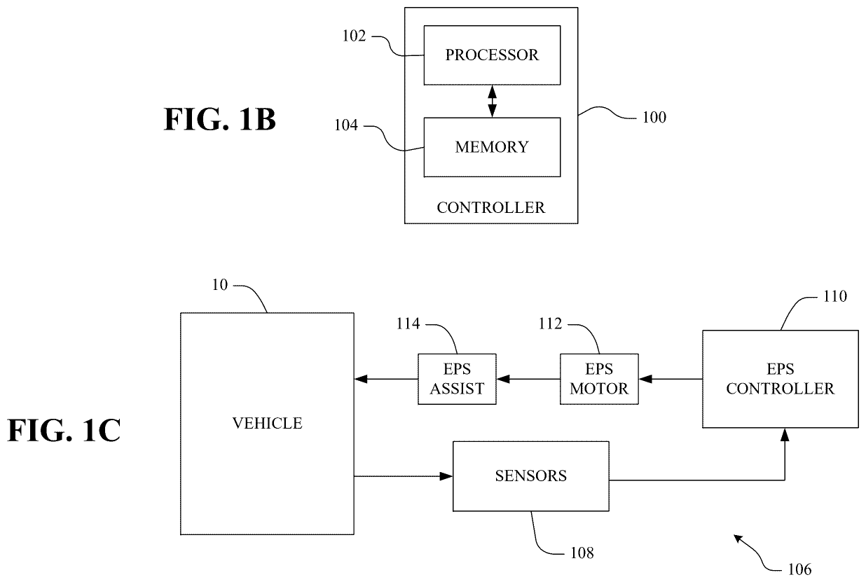

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10. The steering system of the present disclosure is configured to implement EPS diagnostic techniques as described below in more detail.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller or control circuitry. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors indicating sensed or measured characteristics of the vehicle 10. The sensors may include any suitable sensors, measurement devices, and/or other suitable mechanisms. For example, the sensors may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof. In some embodiments, a controller such as the controller 100 may perform at least some of the functions of the systems and methods described herein, such as functions related to communicating with, providing data to, and receiving data from various components and systems of the vehicle 10.

As shown in FIG. 1C, the vehicle 10 includes and interacts with an example EPS 106. For example, measurements such as handwheel angle and torque signals may be obtained using one or more sensors 108. An EPS controller 110 may be configured to capture and analyze steering intention based on data received from the sensors 108. The EPS controller 110 generates an assist command based on steering intention to control an EPS motor 112, which produces torque to be added to an EPS assist mechanism 114 (e.g., to assist the steering wheel to produce yaw).

The EPS controller 110 may correspond to and/or include one or more embedded controllers, control circuitry, or microcontrollers, such as an MCU (not shown in FIG. 1C; described below in more detail), which may be generally referred to as a “controller.” As used herein, the MCU corresponds to an integrated circuit or other circuitry including one or more processors and memory and is configured to control operation of various electronic components of the EPS controller 110. For example, the MCU may be located at or near components controlled by the MCU (e.g., proximate to a motor used to control an EPS gear or assist mechanism, such as the EPS motor 112), within a steering column, and/or elsewhere within the EPS system 108.

The EPS controller 110 according to the principles of the present disclosure, using the MCU, is configured to monitor and collect/log data associated with operation of the EPS controller 110 as described below in more detail. Further, an external device or controller (e.g., an external computing device, such as a laptop, connected to the vehicle CAN bus via a diagnostic port), a cloud computing system, etc. may be configured to implement at least a portion of the systems and methods described herein. However, the functions described herein as performed by the MCU, the EPS controller 110, an external computing device, etc. are not meant to be limiting, and any type of software executed on a controller, processor, or other circuitry can implement the systems and methods described herein without departing from the scope of this disclosure.

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B.

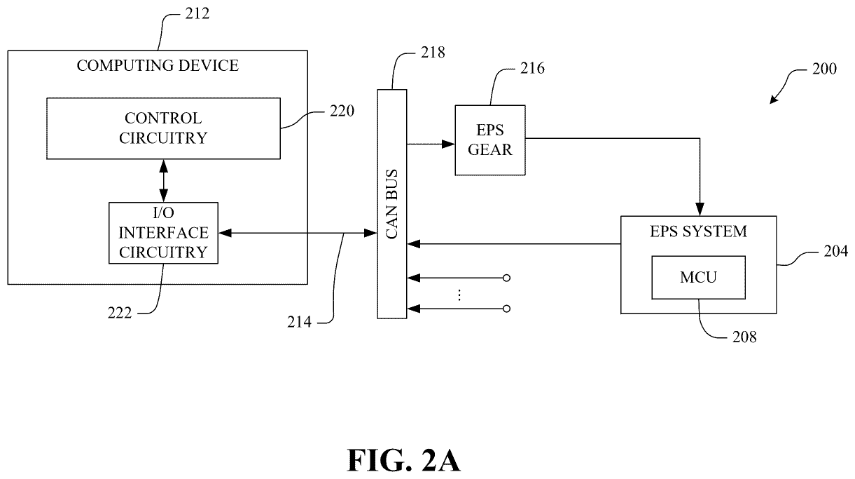

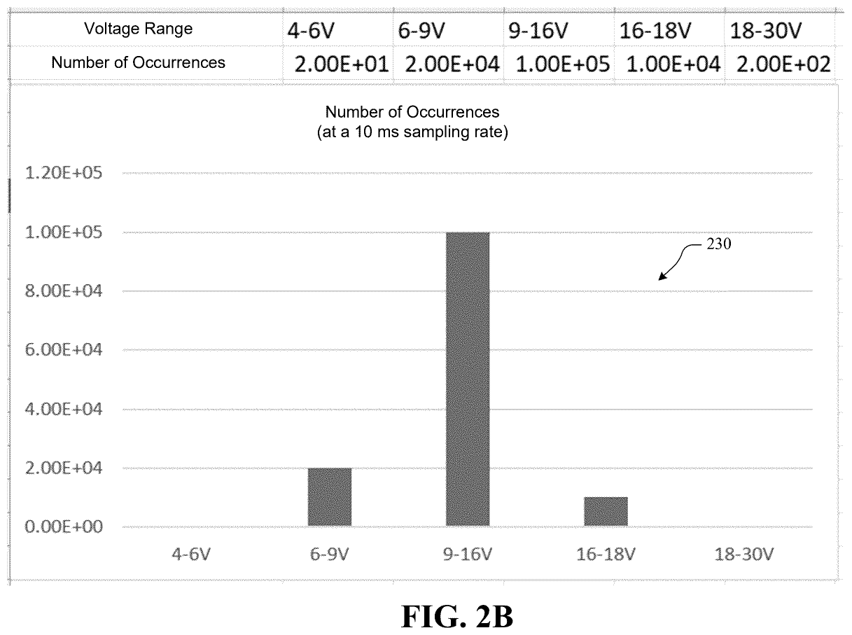

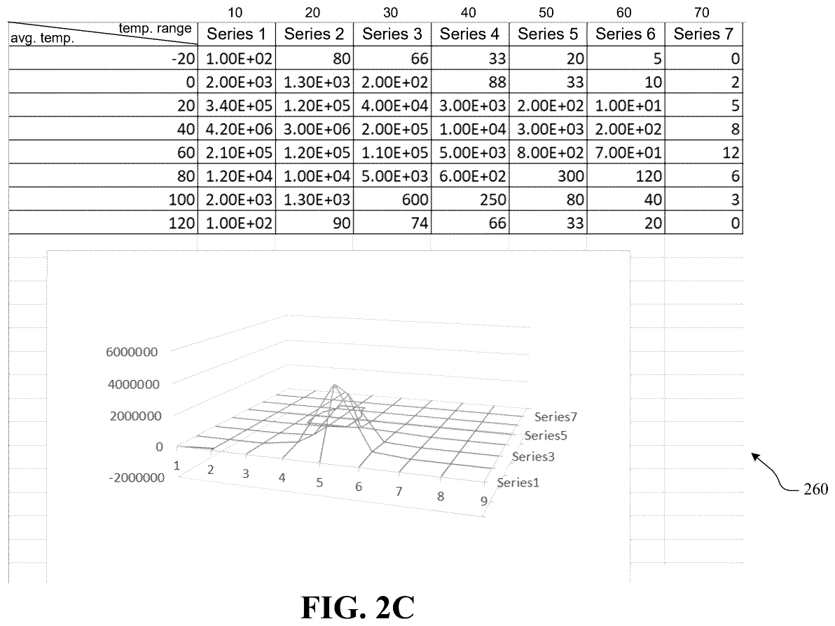

FIG. 2A shows an example diagnostic system 200 according to the present disclosure in more detail. The diagnostic system 200 is configured to monitor and collect/log data associated with operation of an EPS system 204 a vehicle. For example only, the diagnostic system 200 may be implemented using a controller or microcontroller, such as an MCU 208. The MCU 208 may correspond to an embedded MCU of the EPS system 204. In some examples, portions of the diagnostic system 200 may be implemented at least partially using a controller of the vehicle, such as a controller configured in the manner described in FIG. 1B. Portions of the diagnostic system 200 may be implemented at least partially using a computing device 212 external to the vehicle, such as a laptop or diagnostic tool coupled to a diagnostic port (e.g., an on-board diagnostics, or OBD-II, port; represented schematically at 214) of the vehicle. In any of the above examples, components of the diagnostic system 200 may be configured to communicate with each other and vehicle components (e.g., the steering system 204, etc.) using a vehicle network, such as a CAN bus 218.

The computing device 212 may include control circuitry 220, such as a test controller, processor or processing device, etc., configured to execute instructions to communicate with the MCU 208 (e.g. to retrieve diagnostic data from the MCU 208). For example, the control circuitry 212 may be configured to operate and communicate in accordance with UDS protocol, execute/implement, a UDS service, etc. (e.g., via I/O interface circuitry 222).

The MCU 208 according to the principles of the present disclosure is configured to monitor and collect/log diagnostic data associated with operation of the EPS system 204. More specifically, the MCU 208 is configured to monitor operating data associated with operation of the EPS system 204 and relevant components (e.g., the EPS gear 216, a T-box, a rack and pinion assembly, associated sensors, etc.) and collect and store the diagnostic data based on the operating data. The MCU 208 is configured to collect and store the diagnostic data for subsequent retrieval (e.g., retrieval by an external diagnostic tool or device, such as the computing device 212, configured to connect to and communicate with the MCU 208 via the port 214 and the CAN bus 218).

Referring now to FIGS. 2B and 2C with continued reference to FIG. 2A, diagnostic data collection and storage according to the principles of the present disclosure are described in more detail. The diagnostic data may include one or more counts or counters indicating a number of occurrences of different operating characteristics (e.g., as indicated by the monitored operaing data) within different interval ranges, which can be readily obtained and stored within the MCU 208. The number of occurences of various operating characteristics within the different interval ranges may provide more detailed information regarding faults, including both information prior to the occurence of any faults (e.g., for fault prevention/prediction) and information about behavior of the EPS system leading up to the actual occurence of a fault. In the examples described below, the diagnostic data corresponds to measured voltages indicated by the operating data, but other types of measured/sensed/calcluated data (e.g., currents, temperatures, torques, speeds, etc.) may be similarly represented by diagnostic data in accordance with the principles of the present disclosure.

As shown in FIG. 2B, example diagnostic data 230 shows a number of occurences of a particular measurement (e.g., a voltage) in respective voltage ranges. The diagnostic data 230 of FIG. 2B may correspond to one-dimensional data. In other words, the diagnostic 230 only shows an overall count of the corresponding measurement over a given time period. As shown, the voltage ranges include, for example only, a 4.0-6.0 volt range, a 6.0-9.0 volt range, a 9.0-16.0 volt range, a 16.0-18.0 volt range, and an 18.0-30.0 volt range. In this example, the diagnostic data 230 indicates respective numbers of occurences counted in each of the 6.0-9.0 volt range, the 9.0-16.0 volt range, and the 16.0-18.0 volt range (e.g., 2.00E+04, 1.00E+05, and 1.00E+04, respectively).

The numbers of occurences may correspond to counts obtained by sampling at 10 ms intervals (e.g., counter intervals or counter resolution) over the given time period (e.g., a lifetime of the vehicle, a time since a last maintenance or service session, etc.). The counter interval can be increased or decreased (e.g., in accordance with calibration preferences), set at different values for different types of measurements/characteristics (e.g., set at different respective values for voltage, current, temperature, etc.), and so on to adjust data granularity/update frequency. For example, various characteristics may be more or less volatile, may remain in a given range for shorter or longer durations, etc. As one example, characteristics such as voltage and current may have greater variation/volatility and therefore have an associated counter resolution of 10 ms. Conversely, a characteristic such as temperature may have less variation/volatility (and remain in a given range for longer periods of time relative to voltage and current) and therefore have an associated counter resolution of 1 second. Memory/storage space requirements for given measurement types may vary based on the counter resolution and reserved in memory accordingly.

In this manner, each time the measurement of the characteristic is in a particular range, the corresponding count for that range is increased. As one example, the MCU 208 is configured to implement a real-time logging counter or counters (e.g., a separate counter or memory storage location for each measurement type, range, etc.) that are updated each time a particular characteristic is observed/measured in a corresponding range. For example, during power-on operation of the vehicle, the MCU 208 may update/increment counters implemented in a volatile memory (e.g., RAM) portion of the MCU 208. Prior to powering down the vehicle and/or the MCU 208, the diagnostic data 230 as stored in the volatile memory is written to a non-volatile memory or storage (e.g. flash memory, EEPROM, etc.). For example, the MCU 208 may be configured to transfer and/or copy the diagnostic data 230 to non-volatile memory in response to receiving an indication that the vehicle is powering down and/or periodically during operation (e.g., at 30 second intervals, 5 minute intervals, etc.). As used herein, “counter” may refer to corresponding memory space, addresses, locations, etc. in a memory or storage device or structure.

The diagnostic data 230 can be retrieved, analyzed, etc. (e.g., retrieved using a diagnostic tool or other device implementing a UDS service as described above). For example, the diagnostic data 230 may be retrieved subsequent to a fault or failure to analyze the various counts of the characteristics over time, in a time period leading up to the fault, etc. As another example, the diagnostic data 230 may be retrieved and analyzed prior to any fault occurrences, during routine maintenance or servicing, etc. to evaluate risk for future fault occurrences.

In this manner, continuous time-domain data (e.g., real-time measurements of various operating characteristics) is converted into discrete count data to reduce required memory space without losing data. In other words, without needing to record/store data indicating actual discrete measurements (i.e., actual measured current, voltage, temperature, etc. values) and instead simply counting number of occurrences in respective ranges, all occurrences of respective measurements/characteristics in various ranges can be monitored, stored/recorded, and subsequently retrieved and analyzed.

Referring now to FIG. 2C, example diagnostic data 260 is shown as two-dimensional data. In this example, the diagnostic data 260 shows a number of occurences of a particular measurement of temperature in respective ranges (e.g., measurement/value ranges 1-9) and in different data series. For example, the different data series (e.g., series 1-7) may correspond to different data variation intervals. In this manner, the diagnostic data 260 does not only indicate overall counts of a characteristic in respective ranges but instead indicates average values, variation range, etc. As one example, the two-dimensional data can be used to perform various life estimation techniques, where one dimension of the data 260 may log/indicate a temperature variation range while another dimension logs/indicates average temperature distribution. Information such as temperature variation range and average temperature distribution can be used to estimate residual life of components, such as residual life of a MOSFET associated with a motor, actuator, etc.

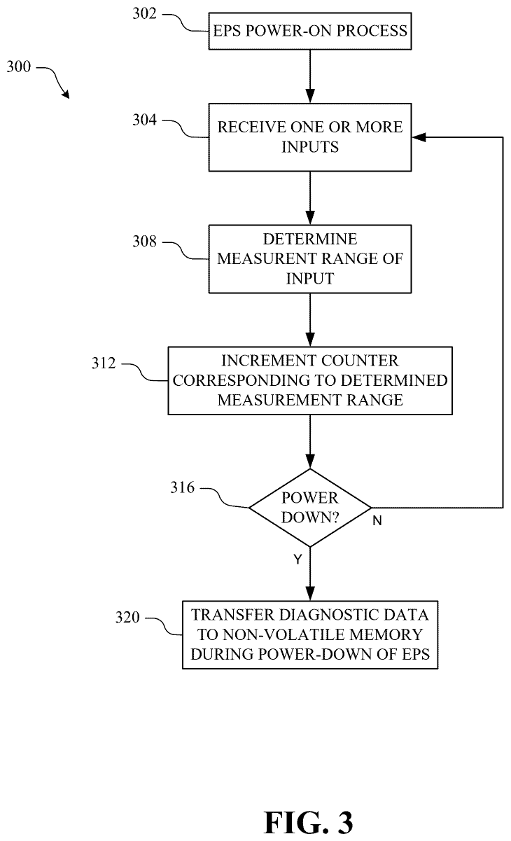

FIG. 3 is a flow diagram generally illustrating a method 300 for measuring, storing, and using diagnostic data according to the principles of the present disclosure. For example, one or more computing devices, processors, or processing devices, etc. are configured to execute instructions to implement the method 300, such as the MCU 208. One or more of the steps of the method 300 as described below may be skipped or omitted in some examples, and/or one or more of the steps may be performed in a different sequence than described. Further, although described with respect to one type of measurement, the steps of the method 300 may be performed for a plurality of different measurement types using respective counters. For example, the steps of the method 300 may be performed in parallel for respective types of measurements such that measurements are obtained for multiple measurement types (i.e., operating characteristics) in real-time.

At 302, the method 300 includes performing an EPS power-on process (e.g., in response to the vehicle being power on). The EPS power-on process may include obtaining diagnostic data stored in non-volatile memory. In this manner, current counter values (i.e., counter values stored in non-volatile memory upon a previous power down of the vehicle, MCU, EPS, etc.) are reloaded into counters to maintain cumulative counting of measurements within respective ranges.

At 304, the method 300 includes receiving one or more inputs (e.g., from respective sensors, models or calculations, etc.) indicative of operating characteristics of a steering system of a vehicle. In this example, the vehicle inputs may include, but are not limited to, inputs indicative of operating characteristics of the steering system, such as various voltages, currents, temperatures, speeds, torques, etc. The one or more inputs are received at an embedded controller, microcontroller, processor, control circuitry, etc., of the steering system, such as an embedded MCU.

At 308, the method 300 includes determining a respective range (e.g., a measurement or value range) for a given input. In other words, for each input, the method 300 includes determining which measurement range, out of a plurality of measurement or value ranges, the input belongs to/resides within.

At 312, the method 300 includes incrementing a counter corresponding to the determined measurement range. For example, incrementing the counter may include incrementing a count of a number of occurrences of the measurement within the determined measurement range (e.g., by incrementing a count stored in a volatile memory location associated with the determined measurement range).

At 316, the method 300 determines whether to store/transfer diagnostic data corresponding to one or more counters to a non-volatile memory. For example, the method 300 may include receiving an indication that the vehicle and/or the MCU is powering down. If true, the method 300 proceeds to 320. If false, the method 300 proceeds to 304 to continue to obtain and store the diagnostic data.

At 320, the method 300 includes transferring/copying the diagnostic data to non-volatile memory (e.g., flash or EEPROM memory of the MCU). For example, the diagnostic data is transferred to the non-volatile memory during a power down process of the vehicle, EPS, etc.

The diagnostic data can then be retrieved from the non-volatile memory whenever the vehicle/MCU are powered on. Retrieving the diagnostic data may include using an external computing device or diagnostic tool to retrieve the diagnostic data from the MCU in accordance with UDS protocol, via a vehicle diagnostic port, etc. as described herein. The diagnostic data may be retrieved in response to detected faults, as part of routing service or maintenance, etc. Subsequent to retrieval, the diagnostic data may be used to determine causes of faults, analyze steering system operating characteristics prior to occurrence of faults, predict faults, recommend servicing or repair, etc. In some examples, the diagnostic data may be transmitted by the vehicle and/or retrieved from the vehicle via wireless communication mechanisms, provided to a remote server, database, cloud computing system, etc. In one example, the systems and methods of the present disclosure may be implemented with remote wireless historical static data read-back techniques (e.g., by reading/retrieving diagnostic data stored within the EPS using a vehicle T-box configured to communicate using UDS protocol, SomeIP protocol, etc.). In this example, the diagnostic data can be selectively retrieved from the EPS without affecting real-time bandwidth.

Subsequent to retrieving the diagnostic data from the MCU, various tasks or functions may be performed based on the diagnostic data, such as analyzing the diagnostic data (and/or generating outputs indicating results) predicting faults or failures based on the diagnostic data, determining causes of faults or failures, generating and outputting alerts to users (e.g., drivers or service professionals), and so on.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for obtaining diagnostic data for an electronic power steering (EPS) system of a vehicle, the method comprising, using one or more processors associated with the EPS system:
receiving one or more inputs indicating respective operating characteristics associated with the EPS system;
determining, from a first plurality of measurement ranges, a first measurement range of a first operating characteristic corresponding to the one or more inputs, wherein the one or more inputs indicate that the first operating characteristic is within the first measurement range; and
incrementing a first counter corresponding to the first measurement range, wherein the first counter stores a first value indicating a number of occurrences of the first operating characteristic within the first measurement range, and wherein the diagnostic data includes the first value stored by the first counter.

2. The method of claim 1, wherein the one or more processors correspond to a microcontroller unit (MCU) of the EPS system.

3. The method of claim 2, wherein the MCU is an embedded MCU of the EPS system.

4. The method of claim 2, wherein the first counter is implemented in memory of the MCU.

5. The method of claim 4, further comprising receiving an indication that at least one of the vehicle and the MCU is being powered down and, in response to receiving the indication, transferring data from volatile memory of the MCU to non-volatile memory of the MCU.

6. The method of claim 4, further comprising retrieving, using an external computing device coupled to a diagnostic port of the vehicle, the diagnostic data from the memory of the MCU in accordance with unified diagnostic services (UDS) protocol.

7. The method of claim 1, further comprising obtaining product life load spectrum data using the diagnostic data.

8. The method of claim 1, further comprising:
determining, from the first plurality of measurement ranges, a second measurement range of the first operating characteristic corresponding to the one or more inputs, wherein the one or more inputs indicate that the first operating characteristic is within the second measurement range; and
incrementing a second counter corresponding to the second measurement range, wherein the second counter stores a second value indicating a number of occurrences of the first operating characteristic within the second measurement range, and wherein the diagnostic data includes the second value stored by the second counter.

9. The method of claim 8, further comprising:
determining, from a second plurality of measurement ranges, a third measurement range of a second operating characteristic corresponding to the one or more inputs, wherein the one or more inputs indicate that the second operating characteristic is within the third measurement range; and
incrementing a third counter corresponding to the third measurement range, wherein the third counter stores a third value indicating a number of occurrences of the second operating characteristic within the third measurement range, and wherein the diagnostic data includes the third value stored by the third counter.

10. The method of claim 1, wherein the operating characteristics include at least one of a voltage, a current, and a temperature associated with the EPS system.

11. A diagnostic system configured to obtain diagnostic data for an electronic power steering (EPS) system of a vehicle, the diagnostic system comprising:
one or more sensors configured to determine respective operating characteristics associated with the EPS system; and
a processor configured to execute instructions stored in memory, wherein executing the instructions causes the processor to
receive one or more inputs indicating the respective operating characteristics associated with the EPS system,
determine, from a first plurality of measurement ranges, a first measurement range of a first operating characteristic corresponding to the one or more inputs, wherein the one or more inputs indicate that the first operating characteristic is within the first measurement range, and
increment a first counter corresponding to the first measurement range, wherein the first counter stores a first value indicating a number of occurrences of the first operating characteristic within the first measurement range, and wherein the diagnostic data includes the first value stored by the first counter.

12. The diagnostic system of claim 11, wherein the processor corresponds to a microcontroller unit (MCU) of the EPS system.

13. The diagnostic system of claim 12, wherein the MCU is an embedded MCU of the EPS system.

14. The diagnostic system of claim 12, wherein the first counter is implemented in memory of the MCU.

15. The diagnostic system of claim 14, wherein executing the instructions further causes the processor to receive an indication that at least one of the vehicle and the MCU is being powered down and, in response to receive the indication, transfer data from volatile memory of the MCU to non-volatile memory of the MCU.

16. The diagnostic system of claim 14, wherein executing the instructions further causes the processor to retrieve, using an external computing device coupled to a diagnostic port of the vehicle, the diagnostic data from the memory of the MCU.

17. The diagnostic system of claim 16, wherein retrieving the diagnostic data includes retrieving the diagnostic data in accordance with unified diagnostic services (UDS) protocol.

18. The diagnostic system of claim 11, wherein the executing the instructions further causes the processor to:
determine, from the first plurality of measurement ranges, a second measurement range of the first operating characteristic corresponding to the one or more inputs, wherein the one or more inputs indicate that the first operating characteristic is within the second measurement range; and
increment a second counter corresponding to the second measurement range, wherein the second counter stores a second value indicating a number of occurrences of the first operating characteristic within the second measurement range, and wherein the diagnostic data includes the second value stored by the second counter.

19. The diagnostic system of claim 18, wherein executing the instructions further causes the processor to:
determine, from a second plurality of measurement ranges, a third measurement range of a second operating characteristic corresponding to the one or more inputs, wherein the one or more inputs indicate that the second operating characteristic is within the third measurement range; and
increment a third counter corresponding to the third measurement range, wherein the third counter stores a third value indicating a number of occurrences of the second operating characteristic within the third measurement range, and wherein the diagnostic data includes the third value stored by the third counter.

20. A method for obtaining diagnostic data for an electronic power steering (EPS) system of a vehicle, the method comprising, using a microcontroller unit (MCU) embedded within the EPS system:
receiving one or more inputs indicating respective operating characteristics associated with the EPS system;
determining, from ama first plurality of measurement ranges, a first measurement range of a first operating characteristic corresponding to the one or more inputs, wherein the one or more inputs indicate that the first operating characteristic is within the first measurement range; and
incrementing a first counter corresponding to the first measurement range, wherein the first counter stores a first value indicating a number of occurrences of the first operating characteristic within the first measurement range, and wherein the diagnostic data includes the first value stored by the first counter.
